(19) United States
(12) Patent Application Publication
(10) Pub. No.: US 2026/0018800 A1
(43) Pub. Date: Jan. 15, 2026

(54) INTELLIGENT REFLECTING SURFACE

(71) Applicant: Japan Display Inc., Tokyo (JP)

(72) Inventors: Daijiro TAKANO, Tokyo (JP); Mitsutaka OKITA, Tokyo (JP)

(73) Assignee: Japan Display Inc., Tokyo (JP)

(21) Appl. No.: 19/335,217

(22) Filed: Sep. 22, 2025

Related U.S. Application Data
(63) Continuation of application No. PCT/JP2024/009286, filed on Mar. 11, 2024.

(30) Foreign Application Priority Data
Apr. 3, 2023 (JP) 2023-060155

(51) Int. Cl. H01Q 15/14; G02F 1/1333; G02F 1/1343; H01Q 3/46

(52) U.S. Cl. CPC H01Q 15/14; G02F 1/133305; G02F 1/1343; H01Q 3/46

(57) ABSTRACT

An intelligent reflecting surface includes a plurality of radio-wave reflection elements. Each of the plurality of radio-wave reflection elements includes a patch electrode, a sub-patch electrode, a counter electrode, a first orientation film, and a second orientation film. The sub-patch electrode is electrically insulated from the patch electrode. The counter electrode opposes the patch electrode and the sub-patch electrode via a liquid crystal layer. The first orientation film is located between the liquid crystal layer and the patch electrode and between the liquid crystal layer and the sub-patch electrode. The second orientation film is located between the liquid crystal layer and the counter electrode.

### CROSS-REFERENCE TO RELATED APPLICATIONS

This application is a Continuation of International Patent Application No. PCT/JP2024/009286, filed on Mar. 11, 2024, which claims the benefit of priority to Japanese Patent Application No. 2023-060155, filed on Apr. 3, 2023, the entire contents of each are incorporated herein by reference.

### FIELD

An embodiment of the present invention relates to an intelligent reflecting surface.

### BACKGROUND

Since liquid crystal molecules have anisotropic permittivity, the permittivity of the liquid crystal layer containing liquid crystal molecules can be controlled by adjusting the electric field applied to the liquid crystal layer to control the orientation of the liquid crystal molecules. It has been known that the application of such characteristics allows the production of an intelligent reflecting surface with controllable reflective characteristics (see, for example, Japanese Lain-Open Patent Publications No. H11-103201 and 2019-530387).

### SUMMARY

An embodiment of the present invention is an intelligent reflecting surface. The intelligent reflecting surface includes a plurality of radio-wave reflection elements. Each of the plurality of radio-wave reflection elements includes a patch electrode, a sub-patch electrode, a counter electrode, a first orientation film, and a second orientation film. The sub-patch electrode is electrically insulated from the patch electrode. The counter electrode opposes the patch electrode and the sub-patch electrode via a liquid crystal layer. The first orientation film is located between the liquid crystal layer and the patch electrode and between the liquid crystal layer and the sub-patch electrode. The second orientation film is located between the liquid crystal layer and the counter electrode.

### BRIEF DESCRIPTION OF DRAWINGS

FIG. 1 is a schematic top view of an intelligent reflecting surface according to an embodiment of the present invention.

FIG. 2 is a schematic top view of a radio-wave reflection unit included in an intelligent reflecting surface according to an embodiment of the invention.

FIG. 3 is a schematic cross-sectional view of a radio-wave reflection unit included in an intelligent reflecting surface according to an embodiment of the invention.

FIG. 4A is a schematic top view of a portion of an intelligent reflecting surface according to an embodiment of the present invention.

FIG. 4B is a schematic top view of a portion of an intelligent reflecting surface according to an embodiment of the present invention.

FIG. 5 is a schematic cross-sectional view of a radio-wave reflection unit included in an intelligent reflecting surface according to an embodiment of the invention.

FIG. 6 is a schematic cross-sectional view of a radio-wave reflection unit included in an intelligent reflecting surface according to an embodiment of the invention.

FIG. 7 is an equivalent circuit of a radio-wave reflection element included in an intelligent reflecting surface according to an embodiment of the invention.

FIG. 8A is a schematic top view of a radio-wave reflection element included in an intelligent reflecting surface according to an embodiment of the invention.

FIG. 8B is a schematic top view of a radio-wave reflection element included in an intelligent reflecting surface according to an embodiment of the invention.

FIG. 9A is a schematic top view of a radio-wave reflection element included in an intelligent reflecting surface according to an embodiment of the invention.

FIG. 9B is a schematic top view of a radio-wave reflection element included in an intelligent reflecting surface according to an embodiment of the invention.

FIG. 10A is a schematic top view of a radio-wave reflection element included in an intelligent reflecting surface according to an embodiment of the invention.

FIG. 10B is a schematic top view of a radio-wave reflection element included in an intelligent reflecting surface according to an embodiment of the invention.

FIG. 11A is a schematic top view of a radio-wave reflection element included in an intelligent reflecting surface according to an embodiment of the invention.

FIG. 11B is a schematic top view of a radio-wave reflection element included in an intelligent reflecting surface according to an embodiment of the invention.

FIG. 12A is a schematic top view of a radio-wave reflection element included in an intelligent reflecting surface according to an embodiment of the invention.

FIG. 12B is a schematic top view of a radio-wave reflection element included in an intelligent reflecting surface according to an embodiment of the invention.

### DESCRIPTION OF EMBODIMENTS

Hereinafter, each embodiment of the present invention is explained with reference to the drawings. The invention can be implemented in a variety of different modes within its concept and should not be interpreted only within the disclosure of the embodiments exemplified below.

The drawings may be illustrated so that the width, thickness, shape, and the like are illustrated more schematically compared with those of the actual modes in order to provide a clearer explanation. However, they are only an example, and do not limit the interpretation of the invention. In the specification and the drawings, the same reference number is provided to an element that is the same as that which appears in preceding drawings, and a detailed explanation may be omitted as appropriate.

In the specification and the claims, unless specifically stated, when a state is expressed where a structure is arranged “over” another structure, such an expression includes both a case where the substrate is arranged immediately above the “other structure” so as to be in contact with the “other structure” and a case where the structure is arranged over the “other structure” with an additional structure therebetween.

In the specification and claims, an expression that a structure is exposed from another structure means a mode where the portion of the structure is not covered by the other structure and includes a mode where the portion uncovered by the other structure is further covered by another structure. In addition, a mode expressed by this expression includes a mode where the structure is not in contact with the other structures.

In the embodiments of the present invention, when a plurality of films is simultaneously fabricated in the same process, these films have the same layer structure, the same material, and the same composition. Thus, these films are defined as existing in the same layer.

### 1. Overall Structure of Intelligent Reflecting Surface

Hereinafter, the structure of an intelligent reflecting surface 100 according to an embodiment of the present invention is explained. The intelligent reflecting surface 100 is a so-called liquid crystal intelligent reflecting surface which selectively reflects radio waves with a specific frequency among incident radio waves in arbitrary directions and blocks the radio waves with other frequencies by utilizing permittivity changes caused by orientation changes of the liquid crystal layer induced by electric fields. There are no restrictions on the frequencies of radio waves capable of being reflected, and the frequencies are in the range of 400 MHz to 50 GHz, for example. Typically, the intelligent reflecting surface 100 may be used to reflect radio waves in the 400 MHz to 6.0 GHz band, the 2.5 GHz to 4.7 GHz band, and the 24 GHz to 50 GHz band.

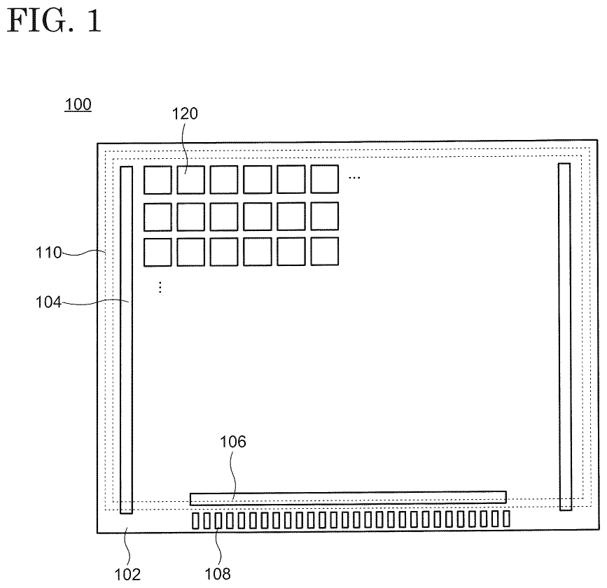

FIG. 1 shows a schematic top view of the intelligent reflecting surface 100. The intelligent reflecting surface 100 has a substrate (hereinafter, referred to as an array substrate) 102, and a plurality of radio-wave reflection units 120 arranged in a matrix shape with a plurality of columns and a plurality of rows is provided over the array substrate 102. The region in which the radio-wave reflection units 120 are arranged (a single minimum rectangular region simultaneously surrounding all of the radio-wave reflection units 120) is called a radio-wave reflection region. A region surrounding the radio-wave reflection region is called a frame region or a peripheral region.

Driver circuits (scanning-line driver circuit 104 and signal-line driver circuit 106) for driving the radio-wave reflection units 120 may be provided in the frame region of the array substrate 102. A plurality of wirings which is not illustrated in FIG. 1 is further provided over the array substrate 102. The wirings electrically connect the driver circuits and the radio-wave reflection units 120, and at least some of the wirings extend through the frame region and reach an edge portion of the array substrate 102. The wirings are exposed at the edge portion of the array substrate 102 and constitute a plurality of terminals 108. A connector (not illustrated) such as a flexible printed circuit (FPC) board is connected to the terminals 108. Power and a variety of driving signals for driving the intelligent reflecting surface 100 are supplied from an external circuit via the connector and the terminals 108, while the driver circuits generate control signals to control the radio-wave reflection units 120 on the basis of the driving signals and supply them to the radio-wave reflection units 120. Note that the scanning-line driver circuit 104 and/or the signal-line driver circuit 106 may not be provided, and the control signals may be directly supplied from an external circuit to the radio-wave reflection units 120.

A counter substrate which is not illustrated in FIG. 1 is disposed over the array substrate 102, and the radio-wave reflection units 120 and the driver circuits are sandwiched between and protected by the array substrate 102 and the counter substrate. The array substrate 102 and the counter substrate are fixed to each other by a sealing material 110, and the space formed by the array substrate 102, the counter substrate, and the sealing material 110 is filled with a liquid crystal layer (described below). The characteristics of each radio-wave reflection unit 120 can be controlled by changing the permittivity of the liquid crystal layer using the radio-wave reflection units 120, by which the radio waves to be reflected can be selected and the reflection direction thereof can be controlled.

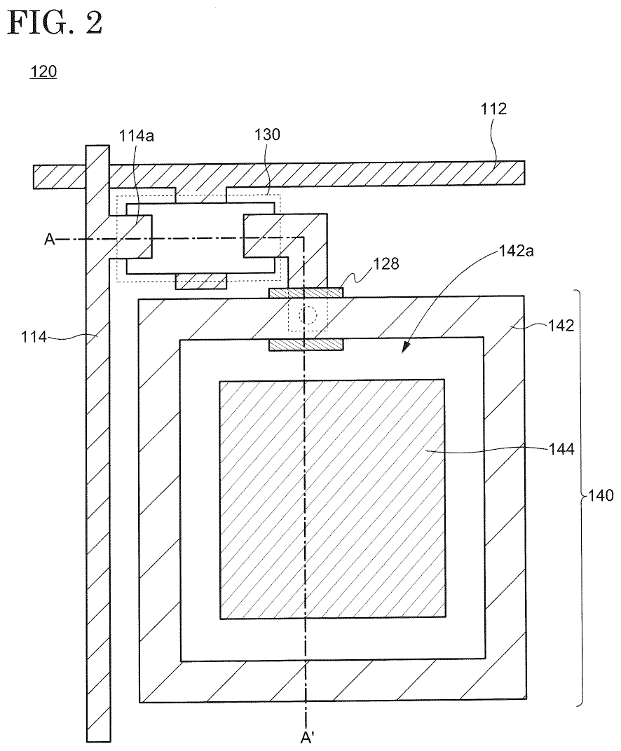

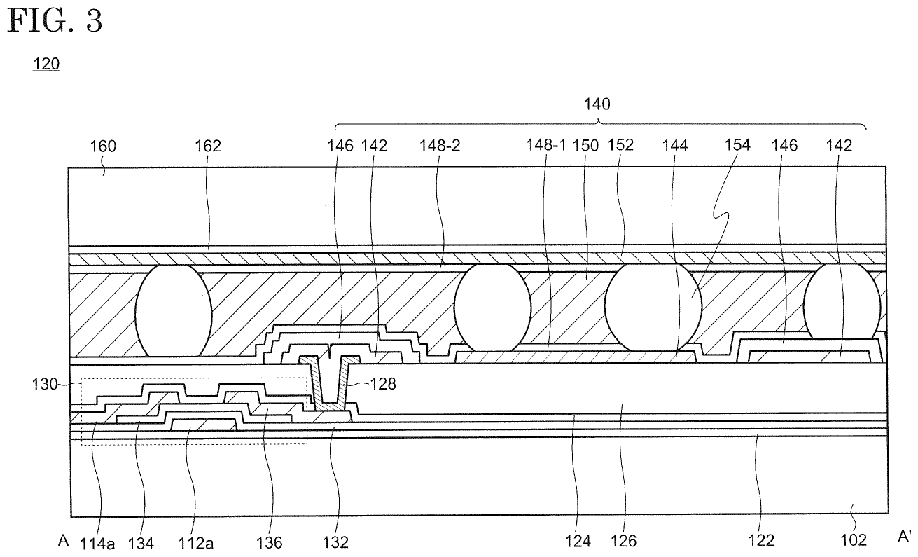

Hereinafter, these components are described in detail, using a schematic top view of the radio-wave reflection unit 120 shown in FIG. 2 as well as FIG. 3 which is a schematic view of the cross section along the chain line A-A′ in FIG. 2.

### 2. Array Substrate and Counter Substrate

The array substrate 102 and the counter substrate 160 face each other and provide physical strength to the intelligent reflecting surface 100 as well as a surface for arranging the radio-wave reflection units 120 and the driver circuits. The array substrate 102 and the counter substrate 160 may include an inorganic insulator such as glass and quartz, a semiconductor such as silicon, a polymer such as a polyimide, a polycarbonate and a polyester, and a metal such as aluminum, copper and stainless steel. When a conductive material such as a metal is included, it is preferable to respectively provide an insulating undercoat 122 and an insulating overcoat 162 over the surfaces where the radio-wave reflection units 120 are provided, i.e., the surface of the array substrate 102 on the counter substrate 160 side and the surface of the counter substrate 160 on the array substrate 102 side. The array substrate 102 and the counter substrate 160 may or may not transmit visible light. The array substrate 102 and/or the counter substrate 160 may be flexible.

### 3. Radio-Wave Reflection Unit

As shown in FIG. 2, a plurality of gate lines 112 extending from the scanning-line driver circuits 104 and a plurality of signal lines 114 extending from the signal-line driver circuit 106 are disposed over the array substrate 102. The plurality of radio-wave reflection units 120 is arranged in a matrix shape having a plurality of rows and a plurality of columns (see FIG. 1). Each radio-wave reflection unit 120 is connected to the gate line 112 and the signal line 114 and is supplied with the control signals. Each radio-wave reflection unit 120 has an element circuit including a transistor 130 as well as a radio-wave reflection element 140 electrically connected to the element circuit.

### (1) Element Circuit

The structure of the element circuit may be arbitrarily determined, and the element circuit may be configured by combining one or a plurality of transistors and one or a plurality of capacitor elements as appropriate. There are also no restrictions on the structure of the transistors provided in the element circuit, and both a bottom-gate type transistor and top-gate type transistor may be employed. Alternatively, the transistor may be a transistor with gate electrodes over and under a semiconductor film. The transistor 130 illustrated in FIG. 2 and FIG. 3 is a bottom-gate type transistor and is composed of a gate electrode 112a which is part of the gate line 112, a gate insulating film 132 covering the gate electrode 112a, a semiconductor film 134 over the gate insulating film 132, a source electrode 114a electrically connected to the semiconductor film 134 and structuring a part of the signal line 114, and a drain electrode 136, and the like. A leveling film 126 is provided over the element circuit directly or through an interlayer insulating film 124, which is an optional component, over which the radio-wave reflection element 140 is arranged. Unevenness caused by the element circuit can be absorbed by providing the leveling film 126, which allows the radio-wave reflection element 140 to be arranged over a flat surface.

The gate line 112, the signal line 114, each component structuring the transistor 130, the interlayer insulating film 124, the leveling film 126, and the like can be formed by using known materials and applying known methods as appropriate. Thus, a detailed description is omitted. In brief, the gate line 112, the signal line 114, the gate electrode 112a, the source electrode 114a, the drain electrode 136, and the like are fabricated by forming a film containing a metal such as tantalum, molybdenum, titanium, aluminum, or the like using a sputtering method or a chemical vapor deposition (CVD) method followed by patterning the film appropriately utilizing a photolithography process. The semiconductor film 134 is formed as a film containing a Group 14 element exemplified by silicon or an oxide of a Group 13 element such as indium and gallium. The semiconductor film 134 may also be formed by applying a sputtering method or a CVD method. The gate insulating film 132, the interlayer insulating film 124, the undercoat 122, the overcoat 162, and the like include an inorganic compound exemplified by a silicon-containing inorganic compound such as silicon oxide and silicon nitride and are formed by applying a sputtering method or a CVD method. The leveling film 126 includes a polymer such as an acrylic resin, an epoxy resin, a polyimide, a polyamide, and a silicon resin and may be formed by applying a wet film-forming method such as a spin coating method, an inkjet method, and a printing method as appropriate.

### (2) Radio-Wave Reflection Element

The radio-wave reflection element 140 has a sub-patch electrode 142 electrically connected to the element circuit directly or via a connecting electrode 128, which is an optional component, a patch electrode 144 electrically insulated from the sub-patch electrode 142, a liquid crystal layer 150, and a counter electrode 152 (also called a common electrode) opposing the sub-patch electrode 142 and the patch electrode 144 via the liquid crystal layer 150 and electrically connected to the patch electrode 144. The radio-wave reflection element 140 further includes a pair of orientation films (a first orientation film 148-1 and a second orientation film 148-2). The first orientation film 148-1 is disposed between the sub-patch electrode 142 and the liquid crystal layer 150 and between the patch electrode 144 and the liquid crystal layer 150, while the second orientation film 148-2 is disposed between the liquid crystal layer 150 and the counter electrode 152. The radio waves are incident from the side where the sub-patch electrode 142 and patch electrode 144 are provided.

### (A) Sub-Patch Electrode, Patch Electrode, and Counter Electrode

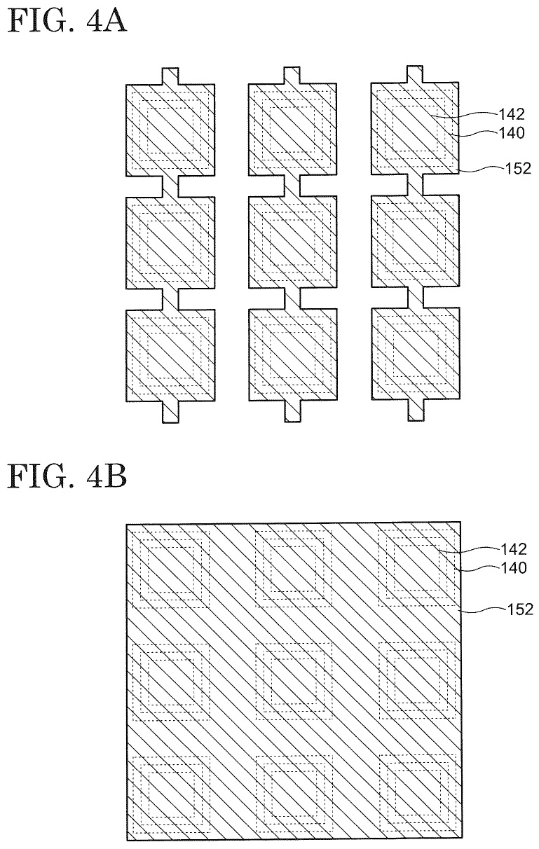

The sub-patch electrode 142 and the patch electrode 144 form a pair and are arranged in each radio-wave reflection unit 120. On the other hand, the counter electrode 152 may be arranged for each or some of the radio-wave reflection units 120 as shown in FIG. 4A or may be arranged to be shared by all of the radio-wave reflection units 120 (FIG. 4B). When a plurality of counter electrodes 152 is provided in one intelligent reflecting surface 100 as in the former case, these counter electrodes 152 are electrically connected to one another in the row direction and/or the column direction, and a substantially equipotential is maintained within the intelligent reflecting surface 100.

As can be understood from FIG. 2 and FIG. 3, the patch electrode 144 is surrounded by the sub-patch electrode 142 in each radio-wave reflection element 140. Thus, the patch electrode 144 and the sub-patch electrode 142 are physically separated and electrically insulated from each other. In the example shown in these drawings, the outer contour of the sub-patch electrode 142 is quadrangular, and the quadrangular patch electrode 144 is arranged in an opening 142a of the sub-patch electrode 142. Preferably, the patch electrode 144 and the sub-patch electrode 142 have a highly symmetrical shape so that both orthogonal components of radio waves (vertically and horizontally polarized waves) are efficiently reflected. For example, the outer contour of the sub-patch electrode 142 and the shapes of the opening 142a and the patch electrode 144 are preferred to be a regular square. In addition, these electrodes are preferred to be arranged so as to have a symmetry axis in the row direction and the column direction. Such an arrangement also contributes to efficient reflection of the vertically and horizontally polarized waves.

The lengths of the patch electrode 144 in the row direction and the column direction may be selected from a range equal to or greater than 0.5 mm and equal to or less than 5 mm or equal to or greater than 1 mm and equal to or less than 3 mm, depending on the frequency of the radio waves to be reflected. On the other hand, the lengths of the outer contour of the sub-patch electrode 142 in the row direction and the column direction may be selected from a range equal to or greater than 5 mm and equal to or less than 10 mm or equal to or greater than 5 mm and equal to or less than 8 mm. Note that it is preferred to adjust the shapes of the sub-patch electrode 142 and the patch electrode 144 so that the area of the sub-patch electrode 142 is larger than the area of the patch electrode 144. This structure allows the design of the electrode size which matches the wavelength of the radio waves to be controlled.

The sub-patch electrode 142, the patch electrode 144, and the counter electrode 152 include, for example, a metal (0 valent metal) such as copper, aluminum, tungsten, molybdenum, and titanium, an alloy containing at least one of these metals, or the like. Alternatively, these electrodes may include a conductive oxide with a light-transmitting property such as indium-zinc oxide (IZO) and indium-tin oxide (ITO). These electrodes may have a single layer structure or a stacked-layer structure in which layers of different compositions are stacked. For example, a stacked-layer structure of a layer containing a conductive oxide and a layer containing the above metal or alloy may be employed. When these electrodes include a 0 valent metal, these electrodes may have a mesh shape in order to provide the intelligent reflecting surface 100 with a light-transmitting property. Each radio-wave reflection element 140 may be configured so that the sub-patch electrode 142 and the patch electrode 144 exist in the same layer. In this case, the sub-patch electrode 142 and the patch electrode 144 can have the same composition and thickness.

### (B) Orientation Film and Liquid Crystal Layer

The pair of orientation films 148 is provided to control the orientation of the liquid crystal molecules structuring the liquid crystal layer 150 sandwiched therebetween. The first orientation film 148-1 may be provided continuously over the plurality of radio-wave reflection elements 140. In other words, the first orientation film 148-1 may be provided so as not to be divided between adjacent radio-wave reflection elements 140 but to be shared by all of the radio-wave reflection elements 140. Similar to the first orientation film 148-1, the second orientation film 148-2 may be continuous between adjacent radio-wave reflection elements 140 and may be formed to be shared by the plurality of radio-wave reflection elements 140. The first orientation film 148-1 and the second orientation film 148-2 are arranged so that the direction in which the first orientation film 148-1 orients the liquid crystal molecules is parallel to that of the second orientation film 148-2. The liquid crystal molecules are oriented in a certain direction by the first orientation film 148-1 and the second orientation film 148-2.

The orientation films 148 include a polymer such as a polyimide and a polyester and are formed by utilizing a wet film-forming method such as an ink-jet method, a spin-coating method, a printing method, and a dip-coating method. The surfaces thereof are treated with a rubbing treatment. Alternatively, the orientation films 148 may be formed by a photo-alignment treatment.

As described above, the liquid crystal layer 150 is sealed with the sealing material 110 between the array substrate 102 and the counter substrate 160. The structure of the liquid crystal molecules in the liquid crystal layer 150 is not limited. Thus, the liquid crystal molecules may be nematic liquid crystals, smectic liquid crystals, cholesteric liquid crystals, or chiral smectic liquid crystals. The thickness of the liquid crystal layer 150 is, for example, equal to or greater than 20 μm and equal to or less than 50 μm or equal to or greater than 30 μm and equal to or less than 50 μm. Although not illustrated, a spacer may be provided in the liquid crystal layer 150 to maintain this thickness throughout the intelligent reflecting surface 100. Alternatively, a pillar 156 may be used to obtain a function as a spacer. Note that, if the aforementioned thickness of the liquid crystal layer 150 is employed in a liquid crystal display device, high responsiveness required to display moving images cannot be obtained, and it becomes significantly difficult to express the functions of a liquid crystal display device.

(C) Electrical Connection between Patch Electrode and Counter Electrode

The electrical connection between the patch electrode 144 and the counter electrode 152 may be performed using conductive particles 154 containing a metal such as silver, gold, palladium, aluminum, and copper as shown in FIG. 3. For example, the conductive particles 154 may be mixed with the liquid crystal, and the mixture thereof may be injected between the array substrate 102 and the counter substrate 160 to form the liquid crystal layer 150. When a pressure is applied between the array substrate 102 and the counter substrate 160 at this time, a portion of the conductive particles 154 penetrates the orientation films 148 and contacts the patch electrode 144 and the counter electrode 152. As a result, the patch electrode 144 and the counter electrode 152 are electrically connected. Therefore, it is preferable to provide an insulating film 146 to prevent contact between the sub-patch electrode 142 and the conductive particles 154 and electrical conduction therebetween. The insulating film 146 is provided to expose the patch electrode 144 in order to ensure the electrical connection between the patch electrode 144 and the counter electrode 152. In other words, the insulating film 146 is configured to have a plurality of openings to expose the patch electrode 144. The insulating film 146 may also be configured to include a polymeric material such as an acrylic resin, an epoxy resin, a polyimide, and a polyamide or a silicon-containing inorganic compound.

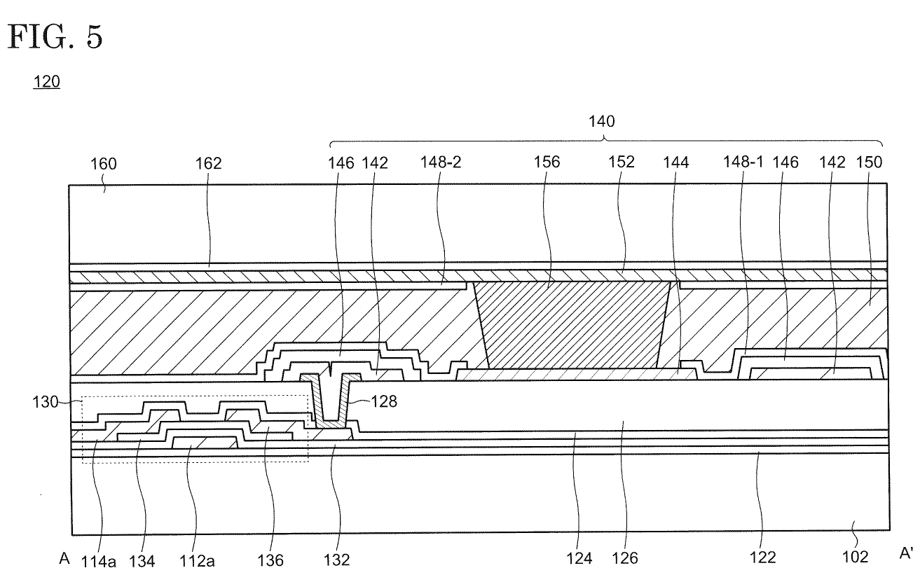

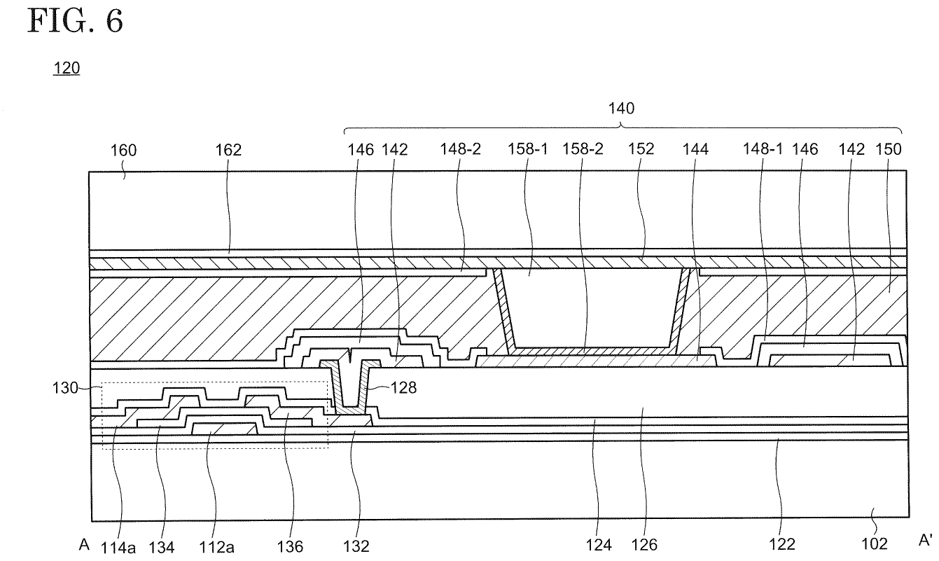

Alternatively, the pillar 156 having a conductive surface may be formed over the counter electrode 152, and the array substrate 102 and the counter substrate 160 may be fixed so that the pillar 156 overlaps the patch electrode 144 to electrically connect the patch electrode 144 and the counter electrode 152 (FIG. 5). In this case, the first orientation film 148-1 is formed so as to have a plurality of openings to expose a part of or the entire patch electrode 144. Similarly, the second orientation film 148-2 is formed to have a plurality of openings to expose a portion of the counter electrode 152 and overlap the patch electrode 144. Here, the entire pillar 156 may be formed using a metal such as aluminum, titanium, molybdenum, tantalum, copper, and tungsten. Alternatively, as shown in FIG. 6, the pillar 156 may be composed of a base 158-1 containing a polymer such as an acrylic resin, an epoxy resin, a silicon resin, a polyamide, and a polyimide and a metal film 158-2 covering the surface of the base 158-1 and containing one or a plurality of the aforementioned metals. The pillar 156 may function as a spacer to control the thickness of the liquid crystal layer 150.

### 4. Control of Reflection Direction

Since the sub-patch electrode 142 is connected to the transistor 130 of the element circuit, the potential of the sub-patch electrode 142 is controlled by the control signal. On the other hand, the patch electrode 144 is electrically connected to the counter electrode 152, and a constant potential is applied to the counter electrode 152. Therefore, a potential difference can be formed between the sub-patch electrode 142 and the patch electrode 144 in accordance with the potential of the control signal by adjusting the potential of the control signal as appropriate.

When the intelligent reflecting surface 100 is not driven, the orientation of the liquid crystal molecules is the same between the radio-wave reflection units 120, and the liquid crystal molecules are splay-oriented because no electric field is generated in the liquid crystal layer 150. Therefore, the permittivity is also constant within the liquid crystal layer 150. As a result, the spread (phase) of the reflected radio waves generated by the reflection of the radio waves incident from the sub-patch electrode 142 side on the surfaces of the sub-patch electrode 142 and patch electrode 144 does not change, or the amount of phase change is small. Therefore, the incident radio waves are directly or almost directly reflected by the intelligent reflecting surface 100, resulting in the reflected radio waves at an emission angle substantially the same as the incidence angle.

On the other hand, when the intelligent reflecting surface 100 is driven so as to form a potential difference between the sub-patch electrode 142 and the patch electrode 144 and between the sub-patch electrode 142 and the counter electrode 152, the orientation of the liquid crystal molecules is changed by the generated electric field. The permittivity of the liquid crystal layer 150 is changed between the radio-wave reflection units 120 according to the intensities of the electric fields by generating the electric fields with different intensity between the radio-wave reflection units 120. As a result, the phase of the reflected radio waves changes, and the reflection direction of the radio waves incident on the radio-wave reflection region can be changed. The reflection direction can be arbitrarily controlled by changing the intensity of the electric field formed in the radio-wave reflection units 120 (i.e., the potential of the sub-patch electrodes 142).

### 5. Selective Reflection of Radio Waves

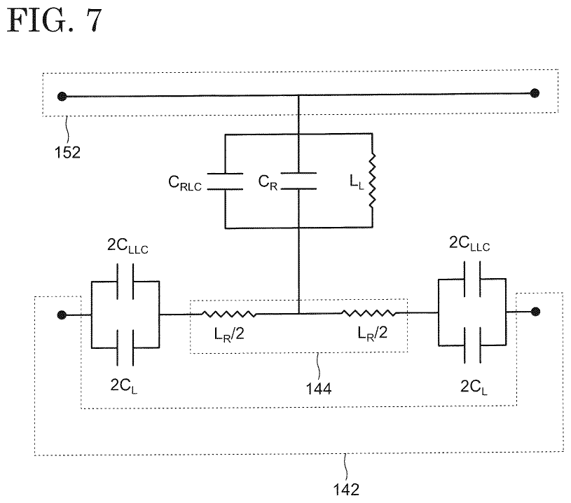

FIG. 7 shows an equivalent circuit of the circuit formed by the sub-patch electrode 142, the patch electrode 144, and the counter electrode 152 of the radio-wave reflection element 140 provided in each radio-wave reflection unit 120. The meanings of the symbols in FIG. 7 are as follows. Here, the inductance L_{L} of a conductive path between the patch electrode 144 and the counter electrode 152 is the inductance of the conductive particles 154 in the example shown in FIG. 3 and the inductance of the pillar 156 in the examples shown in FIG. 4A, FIG. 4B and FIG. 5.
C_{L}: Capacitance between the patch electrode and the sub-patch electrode
C_{LLC}: Liquid crystal capacitance between the patch electrode and the sub-patch electrode
C_{R}: Capacitance between the patch electrode and the counter electrode
C_{RLC}: Liquid crystal capacitance between the sub-patch electrode and the counter electrode
L_{L}: Inductance of the conductive path between the patch electrode and the counter electrode
L_{R}: Inductance of the patch electrode

The structure formed by the sub-patch electrode 142, the patch electrode 144, and the counter electrode 152 has a mushroom structure, which is a sort of metamaterial, and the series resonance frequency fₛₑ and the parallel resonance frequency fₛₕ are expressed by the following formulae according to the equivalent circuit shown in FIG. 7, where ω_{γ2} and ω_{γ1} are the series and parallel resonant angular frequencies, respectively.

$${f}_{s e} = \frac{{ω}_{γ 2}}{2 π} = \frac{1}{2 π \sqrt{{L}_{R} ( {C}_{L} + {C}_{L L C} )}}$$

$${f}_{s h} = \frac{{ω}_{γ 1}}{2 π} = \frac{1}{2 π \sqrt{{L}_{L} ( {C}_{R} + {C}_{R L C} )}}$$

In the mushroom structure, the cutoff frequency f_{B} is expressed by the following formula, and radio waves in this cutoff frequency range are not reflected and are blocked.

$${f}_{B} = \vert {f}_{s e} - {f}_{s h} \vert$$

The inductance L_{L} of the conductive path between the patch electrode 144 and the counter electrode 152 and the inductance L_{R} of the patch electrode 144 are determined by the structure of the radio-wave reflection element 140. On the other hand, the liquid crystal capacitance C_{LLC} between the patch electrode 144 and the sub-patch electrode 142 and the liquid crystal capacitance C_{RLC} between the sub-patch electrode 142 and the counter electrode 152 vary depending not only on the structure of the radio-wave reflection element 140 but also on the permittivity of the liquid crystal layer 150. Moreover, in the radio-wave reflection element 140, the orientation of the liquid crystal molecules in the liquid crystal layer 150 is changed by controlling the intensities of the electric fields between the sub-patch electrode 142 and the patch electrode 144 and between the sub-patch electrode 142 and the counter electrode 152 as described above. As a result, the permittivity of the liquid crystal layer 150 can be controlled according to the intensities of the electric fields. Hence, the liquid crystal capacitance C_{LLC} and the liquid crystal capacitance C_{RLC} can be controlled by controlling the potential applied to the sub-patch electrode 142, and furthermore, the cutoff frequency f_{B} can be varied as understood from the above formulae.

As described above, the intelligent reflecting surface 100 is able to not only control the reflection direction of radio waves but also block radio waves in an arbitrary frequency range among the incident radio waves and selectively reflect only other radio waves, i.e., radio waves with specific frequencies. Therefore, interference to the reflected radio waves by radio waves of unintended frequencies can be prevented, and degradation of signals contained in the radio waves can be prevented or suppressed.

### 6. Modified Examples

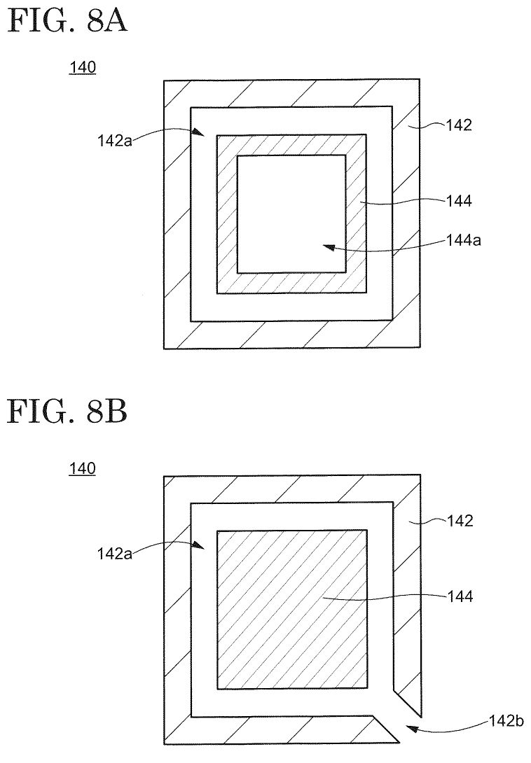

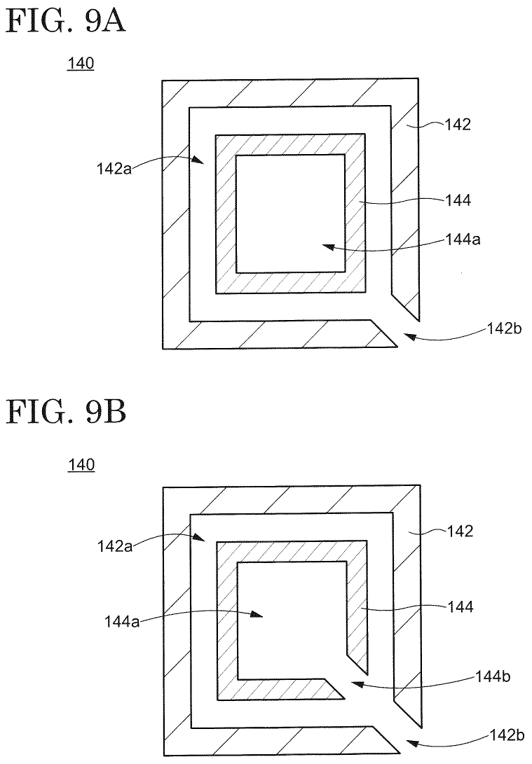

In the example described above, the sub-patch electrode 142 having the opening 142a and a quadrangular outer contour surrounds the quadrangular patch electrode 144 having no opening. However, the shapes of the sub-patch electrode 142 and patch electrode 144 are not limited thereto. For example, the patch electrode 144 may have a circular or quadrangular (preferably square) opening 144a as shown in FIG. 8A, FIG. 9A, and 9B. In this case, the sub-patch electrode 142 and the patch electrode 144 are preferably arranged so that the centers (or centers of gravity) of the openings 142a and 144a of the sub-patch electrode 142 and patch electrode 144 overlap each other on the normal line of the array substrate 102. Alternatively, one or both of the sub-patch electrode 142 and the patch electrode 144 may have cutoffs (slits) 142b and 144b reaching the openings 142a and 144a as shown in FIG. 8B to FIG. 9B. In other words, one or both of the sub-patch electrodes 142 and patch electrodes 144 may have a C-shape.

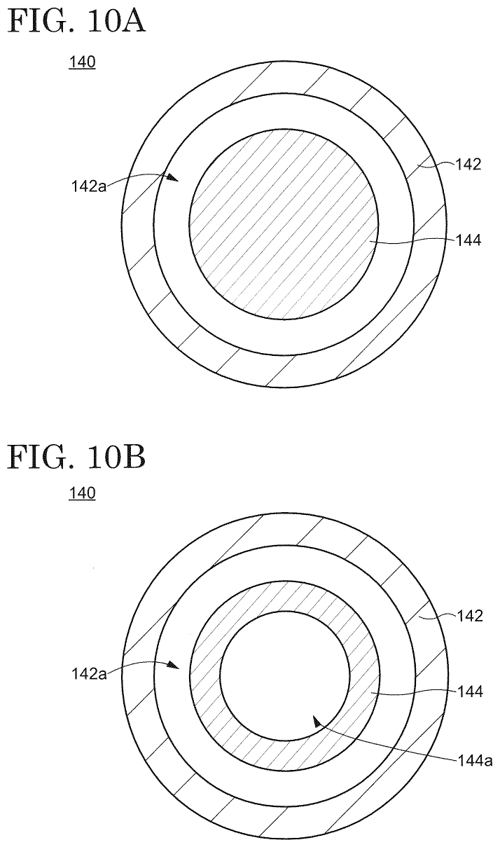

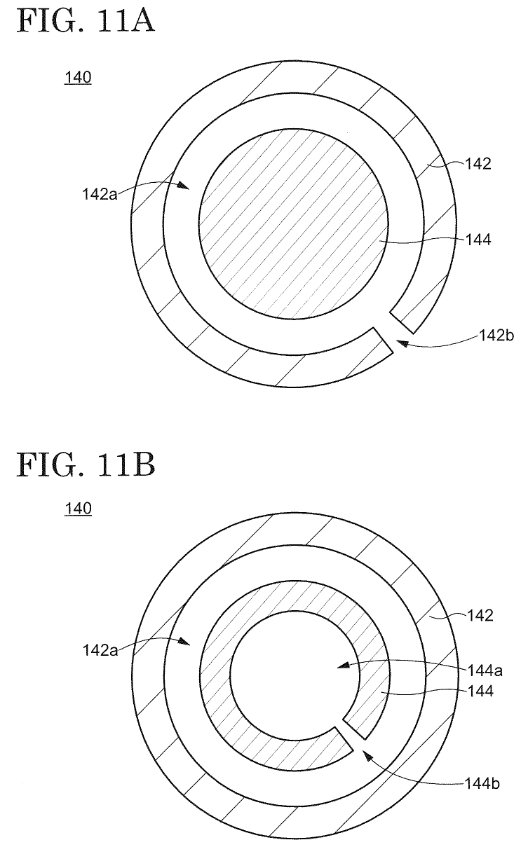

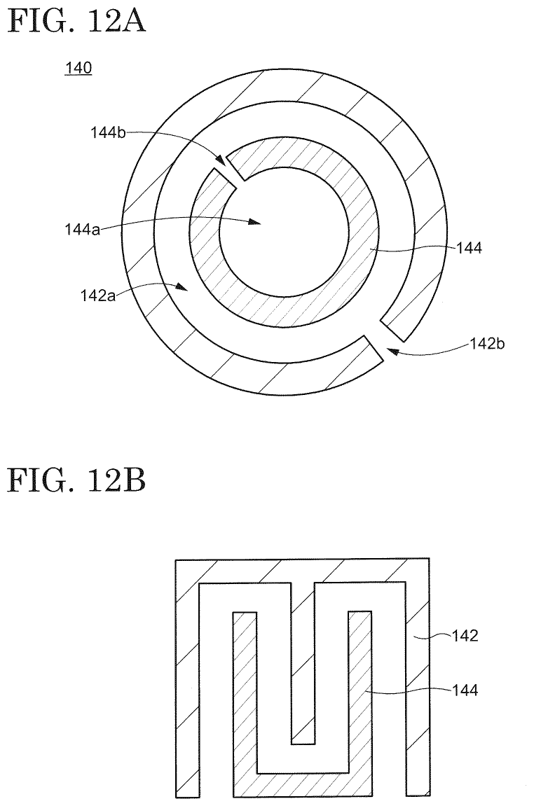

Alternatively, the outer contour of the sub-patch electrode 142 may be a circle, and the shape of the patch electrode 144 (or its outer contour) may also be a circle as shown in FIG. 10A to FIG. 12A. In these cases, the patch electrode 144 may also have a circular or quadrangular (preferably square) opening 144a. Furthermore, one or both of the sub-patch electrode 142 and the patch electrode 144 may have a C-shape as shown in FIG. 11A to FIG. 12A. That is, one or both of the sub-patch electrode 142 and the patch electrode 144 may respectively have slits 142b and 144b.

Alternatively, the sub-patch electrode 142 may have a comb shape as shown in FIG. 12B. In this case, the patch electrode 144 has a plurality of straight portions through a bent portion and is arranged so that at least a portion is sandwiched between adjacent comb teeth of the sub-patch electrode 142.

In the above-mentioned modified examples, the permittivity of the liquid crystal layer 150 can be controlled for each of the radio-wave reflection elements 140 by controlling the potentials provided to the sub-patch electrode 142, the patch electrode 144, and the counter electrode 152. Thus, the reflection direction of incident radio waves can be arbitrarily controlled. In addition, the equivalent circuit shown in FIG. 7 is also constructed by the sub-patch electrode 142, the patch electrode 144, and the counter electrode 152 in these modified examples. Therefore, radio waves in a certain frequency band can be blocked by controlling the potentials of these electrodes. These features enable the intelligent reflecting surface 100 to selectively reflect radio waves of a specific frequency and prevent or suppress the degradation of signals contained in the reflected radio waves.

The aforementioned modes described as the embodiments of the present invention can be implemented by appropriately combining with each other as long as no contradiction is caused. Furthermore, any mode which is realized by persons ordinarily skilled in the art through the appropriate addition, deletion, or design change of elements or through the addition, deletion, or condition change of a process on the basis of the radio-wave reflection unit or the intelligent reflecting surface is included in the scope of the present invention as long as they possess the concept of the present invention.

It is understood that another effect different from that provided by each of the aforementioned embodiments is achieved by the present invention if the effect is obvious from the description in the specification or readily conceived by persons ordinarily skilled in the art.

What is claimed is:

1. An intelligent reflecting surface comprising:
a patch electrode;
a sub-patch electrode electrically insulated from the patch electrode;
a counter electrode opposing the patch electrode and the sub-patch electrode via a liquid crystal layer;
a first orientation film between the liquid crystal layer and the patch electrode and between the liquid crystal layer and the sub-patch electrode; and
a second orientation film between the liquid crystal layer and the counter electrode.

2. The intelligent reflecting surface according to claim 1,
wherein the patch electrode is separated from the sub-patch electrode.

3. The intelligent reflecting surface according to claim 1,
wherein the patch electrode and the sub-patch electrode exist in the same layer as each other.

4. The intelligent reflecting surface according to claim 1,
wherein each of the plurality of radio-wave reflection elements further comprises conductive particles electrically connecting the patch electrode and the counter electrode.

5. The intelligent reflecting surface according to claim 1,
wherein each of the plurality of radio-wave reflection elements further comprises a conductive pillar electrically connecting the patch electrode to the counter electrode.

6. The intelligent reflecting surface according to claim 1,
wherein each of the plurality of radio-wave reflection elements further comprises an insulating film between the sub-patch electrode and the first orientation film, and
at least a portion of a top surface of the patch electrode is exposed from the insulating film.

7. The intelligent reflecting surface according to claim 1,
wherein the patch electrode is surrounded by the sub-patch electrode in each of the plurality of radio-wave reflection elements.

8. The intelligent reflecting surface according to claim 1,
wherein at least one of the patch electrode and the sub-patch electrode has an opening.

9. The intelligent reflecting surface according to claim 1,
wherein at least one of the patch electrode and the sub-patch electrode has a C-shape.

10. The intelligent reflecting surface according to claim 1,
wherein the sub-patch electrode has a comb shape, and adjacent comb teeth sandwich a part of the patch electrode.

11. The intelligent reflecting surface according to claim 1,
wherein a direction in which a liquid crystal molecule included in the liquid crystal layer is oriented by the first orientation film is parallel to that by the second orientation film.
